(19) United States
(12) Patent Application Publication
(10) Pub. No.: US 2024/0005294 A1
(43) Pub. Date: Jan. 4, 2024

(54) DYNAMIC ALLOCATION OF ELECTRONIC WORKFLOWS FOR ELECTRONIC SESSIONS

(71) Applicant: Shopify Inc., Ottawa (CA)

(72) Inventors: Dennis Ho, Ottawa (CA); Devon Meunier, Ottawa (CA)

(73) Assignee: Shopify Inc., Ottawa (CA)

(21) Appl. No.: 17/855,027

(22) Filed: Jun. 30, 2022

(51) Int. Cl. G06Q 20/20; G06Q 30/06; G06Q 20/38

(52) U.S. Cl. CPC G06Q 20/204; G06Q 30/0641; G06Q 20/388

(57) ABSTRACT

A computer-implemented method may comprise receiving a first request to initiate a workflow, the first request being associated with a first session; receiving a second request to initiate the workflow, the second request being associated with a second session; instructing a server to execute a challenge protocol for the first session and the second session, the execution of the challenge protocol causing presentation of one or more responsive elements on respective electronic devices associated with the first session and the second session; receiving one or more indications corresponding to responses to the one or more responsive elements provided by the electronic devices; and responsive to the one or more indications, releasing the second session to proceed with the workflow prior to the first session.

### TECHNICAL FIELD

This application relates generally to dynamic allocation of electronic workflows for electronic sessions.

### BACKGROUND

Most e-commerce systems (and some non-e-commerce systems) and platforms strive to enable buyers to check out and finalize their purchase with as little interaction with the systems as possible. Some conventional systems assume that inventory is abundant and that the merchant desires to maximize the number of sales as quickly as possible. These conventional systems may be configured to order the customers for purchasing the product based on the order that the customers accessed the system. However, in some cases, inventory may be limited, such as when merchants offer exclusive limited edition products, tickets to venues with limited capacity, or other situations where demand greatly exceeds supply. In these cases, a large number of customers may access the merchant's online storefront to purchase a product, which causes various technical issues, such as slower processing time, overuse or misallocation of system resources resulting in slower or delayed checkout time, or higher chances of system crashes resulting in the system becoming unresponsive.

### BRIEF DESCRIPTION OF THE DRAWINGS

The accompanying drawings constitute a part of this specification and illustrate embodiments of the subject matter disclosed herein.

FIG. 1 shows an e-commerce platform, according to an embodiment.

FIG. 2 shows a home page of an administrator, according to an embodiment.

FIG. 3 shows components of a workflow allocation system, according to an embodiment.

FIG. 4 shows execution steps executed in a workflow allocation system, according to an embodiment.

FIG. 5 shows examples of allocating workflow requested by two users using a workflow allocation system, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Disclosed herein are methods and systems that may allow a processor or a server (also referred to herein as the analytics server) to communicate with a third-party challenge server (TPCS) to provide customized challenges that are tailored for different merchants' needs. As used herein, a challenge may refer to executing a challenge protocol that causes presentation of at least one responsive element to validate or evaluate an electronic session (e.g., a customer accessing an online store). The challenge may be presented to a customer at a particular point within the customer's online journey. Specifically, the processor may analyze the customer's electronic session to present a challenge by instructing the TPCS and to allocate workflow processes (e.g., checkout process) to different electronic sessions accordingly (e.g., based on how customers performed in response to the challenge).

I. Example E-Commerce Platform

In some embodiments, the methods disclosed herein may be performed on or in association with a commerce platform, such as an e-commerce platform. Therefore, an example of a commerce platform will be described.

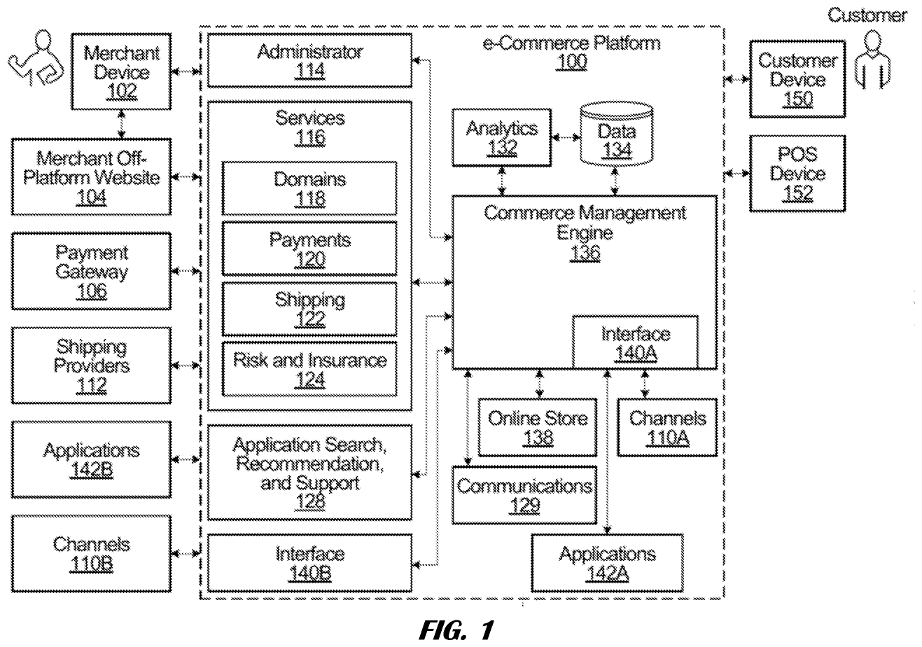

FIG. 1 illustrates an e-commerce platform 100, according to an illustrative system embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the e-commerce platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), and the like. However, even these ‘other’ merchant commerce facilities may be incorporated into the e-commerce platform 100, such as where POS devices 152 in a physical store of a merchant are linked into the e-commerce platform 100, where a merchant off-platform website 104 is tied into the e-commerce platform 100, such as through ‘buy buttons’ that link content from the merchant off-platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop-ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms of online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant device 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The web browser (or other application) of the customer device 150 then renders the page accordingly.

In some embodiments, online stores 138 may be served by the e-commerce platform 100 to customers, where customers can browse and purchase the various products available (e.g., add them to an electronic shopping cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their web site through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g., as data facility 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

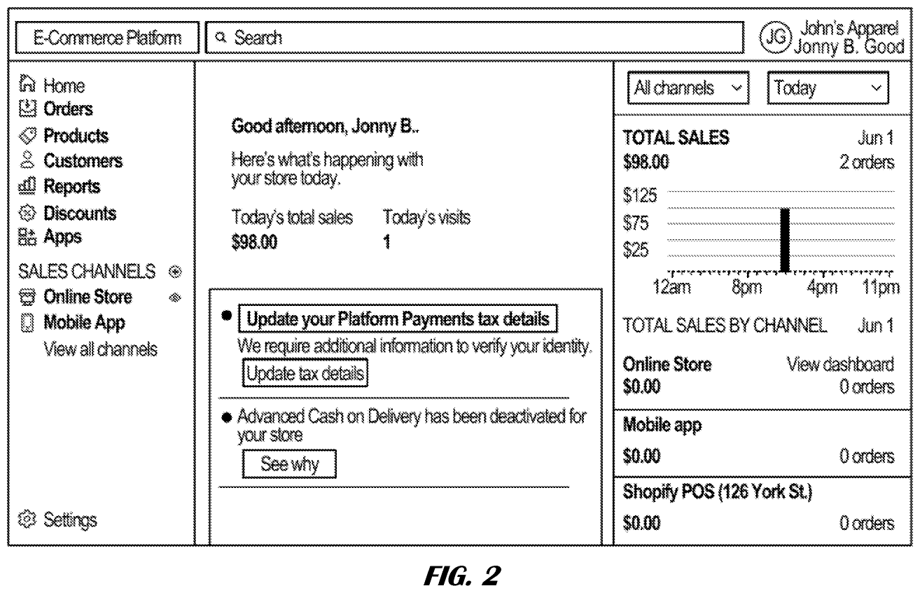

FIG. 2 depicts a non-limiting embodiment for a home page of a merchant administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store 138, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the merchant device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g., via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the e-commerce platform 100 or by a different party. In some embodiments, an application 142B may be provided by the same party providing the e-commerce platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the e-commerce platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the e-commerce platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error-prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension or API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their electronic shopping cart, proceeds to checkout, and pays for the content of their electronic shopping cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their electronic shopping cart (in an alternate embodiment, a product may be purchased directly, such as through a buy button as described herein). Customers may add product variants to their electronic shopping cart. The electronic shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and may track quantities for variants that have inventory tracking enabled. It may decouple product variants (a customer facing concept representing the template of a product listing) from inventory items (a merchant facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that does not provide an API connection). An API fulfillment service may trigger a third-party, where the third-party application creates a fulfillment record. A legacy fulfillment service may trigger a custom API call from the commerce management engine 136 to a third-party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

II. Example Networked Components of System

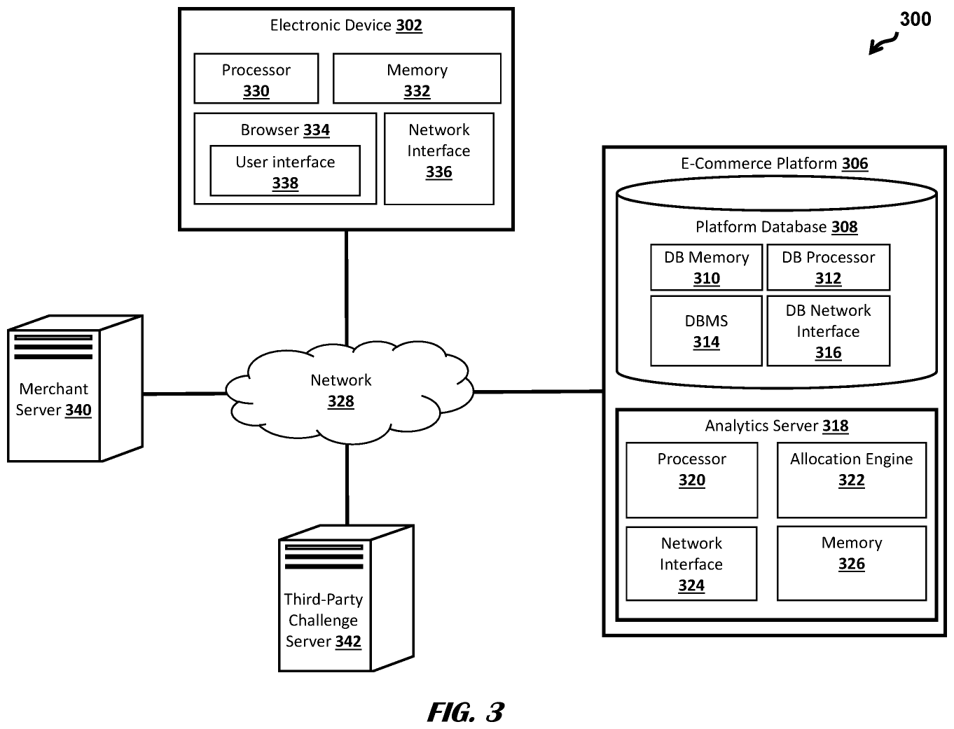

FIG. 3 illustrates components of a workflow allocation system 300, according to an embodiment. The workflow allocation system 300 may include an electronic device 302 and a merchant server 340 communicatively connected with an e-commerce platform 306 via a network 328. The workflow allocation 300 may also include a third-party challenge server (TPCS) 342. The depicted workflow allocation 300 is described and shown in FIG. 3 as having one of each component for ease of description and understanding of an example. The embodiments may include any number of the components described herein. The embodiments may comprise additional or alternative components, or may omit certain components, and still fall within the scope of this disclosure.

The network 328 may include any number of networks, which may be public and/or private networks. The network 328 may comprise hardware and software components implementing various network and/or telecommunications protocols facilitating communications between various devices, which may include devices of the workflow allocation 300 or any number of additional or alternative devices not shown in FIG. 3. The network 328 may be implemented as a cellular network, a Wi-Fi network, or other wired local area network (LAN) or wireless LAN, a WiMAX network, or other wireless or wired wide area network (WAN), and the like. The network 328 may also communicate with external servers of other external services coupled to the network 328, such as servers hosting a social media platform, TPCS 342, a banking platform, or the merchant server 340.

The network 328 may include any number of security devices or logical arrangements (e.g., firewalls, proxy servers, DMZs) to monitor or otherwise manage web traffic to the e-commerce platform 306. Security devices may be configured to analyze, accept, or reject incoming web requests from the electronic device 302, the merchant server 340, and/or the TPCS 342. In some embodiments, the security device may be a physical device (e.g., a firewall). Additionally or alternatively, the security device may be a software application (e.g., Web Application Firewall (WAF)) that is hosted on, or otherwise integrated into, another computing device of the workflow allocation system 300. The security devices monitoring web traffic are associated with and administered by the e-commerce platform 306.

The electronic device 302 may be any electronic device comprising hardware and software components capable of performing the various tasks and processes described herein. Non-limiting examples of the electronic device 302 may include mobile phones, tablets, laptops, and personal computers, among others. When communicating with components of the e-commerce platform 306, the electronic device 302 may generate web traffic (or electronic session data) that is processed by or otherwise accessible to an analytics server (or engine) 318 of the e-commerce platform 306. The web traffic may comprise data packets that include various types of data that can be parsed, analyzed, or otherwise reviewed by various programmatic algorithms of the analytics server 318. For instance, the web traffic data may indicate which website was accessed by a user operating the electronic device 302 (e.g., whether a customer operating the electronic device 302 has accessed a checkout page or added a particular product to their electronic shopping cart).

When customers visit the merchant's online store (or any other website or application identified by the merchant), the analytics server may monitor the customers' activities. As used herein, a session or an electronic session may refer to one or more user interactions between the merchant's online store that take place within a given time frame. For example, a session may refer to a collection of actions performed by a customer when the customer accesses the merchant's online store until the customer logs off, exits the online store, or a time window (rolling or absolute time window) expires. For instance, an electronic session may refer to data corresponding to when the customer logged in, what the customer viewed, what the customer clicked on (or otherwise how the user interacted with the merchant's online store), what the customer has added to their electronic cart, timestamp of when the customer has requested initiation of a workflow.

As used herein, “workflow” may generally refer to any process that is executed by the analytics server, TPCS, and/or the merchant. An example of a workflow may include a checkout process. In a non-limiting example, a customer may request initiating a workflow by interaction with a feature of the merchant's online store. For instance, the customer may click on a button displayed on the merchant's online store that requests the merchant's online store (hosted by the analytics server or a merchant server or another party) to direct the customer to a checkout page. In another example, the workflow may refer to adding a particular product to an electronic shopping cart.

Even though aspects of the workflow discussed herein refer to processes related to e-commerce, the workflow is not limited to e-commerce-related processes. For instance, the workflow may be a request for boarding an airplane or viewing seat prices (or charts) of an event, such as a concert.

In an example, a customer operating the electronic device 302 visits a website of a merchant (e.g., an online store of the merchant) hosted by the merchant server 340 using the browser 334. Therefore, as used herein, the merchant's online store may refer to a graphical user interface (e.g., webpage) within the online store. The merchant's online store may include one or more features hosted (or otherwise produced or functionally controlled) by the analytics server 318. For instance, the analytics server 318 of the e-commerce platform 306 may provide (e.g., host) at least a portion of a webpage for the online store to the electronic device 302 (e.g., checkout page). In some embodiments, the portion of the checkout page may be hosted by the e-commerce platform 306 (e-commerce platform 100 in FIG. 1).

The browser 334 may transmit and receive data packets to display various features of the online store on the user interface 338. The browser 334 (or other application) may connect the electronic device 302 to the analytics server 318 and/or the merchant server 340 using an IP address obtained by translating a domain name. The analytics server 318 and/or the merchant server 340 may execute code associated with the storefront and render the appropriate graphics to be presented to the user interface 338.

Some or all of the features discussed herein may be combined, such that a single entity performs the functionality of the combined features. For instance, the analytics server 318 and the merchant 340 may be combined into a single server and/or either server can perform the functionality of both servers. For instance, in non-limiting examples, the analytics server 318 may also host the storefront (e.g., act as the merchant server 340).

Even though certain embodiments described herein describe the merchant's online store as being hosted by the merchant server 340, it is expressly understood that methods and systems described herein also apply to websites associated with the merchant server 340 that are hosted by a third-party webservers. Furthermore, the methods described herein are also applicable in other environments such as non-ecommerce infrastructures and system architectures.

The merchant's online store presented on the user interface 338 may include an electronic shopping cart and a checkout page where the customer can use the browser 334 to add products and complete the transaction by inputting sensitive information such as payment information. The analytics server 318 (e.g., via the allocation engine 322) may regulate the customers' access to the checkout page. For instance, the analytics server 318 may instruct the browser 334 to display an interface informing the customer to wait until a checkout page is reached.

The electronic device 302 may be a mobile phone, tablet, gaming console, screen-less device, virtual personal assistant device, laptop, or computer owned and/or used by a customer. The electronic device 302 may include a processor 330, memory 332, user interface 338, and network interface 336. An example of a user interface 338 is a display screen (which may be a touch screen), a gesture recognition system, a keyboard, a stylus, and/or a mouse. The network interface 336 is provided for communicating over the network 328. The structure of the network interface 336 will depend on how the electronic device 302 interfaces with the network 328. For example, if the electronic device 302 is a mobile phone or tablet, the network interface 336 may include a transmitter/receiver with an antenna to send and receive wireless transmissions to/from the network 328.

The e-commerce platform 306 is a computing system infrastructure that may be owned and/or managed (e.g., hosted) by an e-commerce service and, in some embodiments, may be the same as or similar to that described with reference to FIGS. 1-2, though this need not be the case. The e-commerce platform 306 includes electronic hardware and software components capable of performing various processes, tasks, and functions of the e-commerce platform 306. For instance, the computing infrastructure of the e-commerce platform 306 may comprise one or more platform networks (not shown) interconnecting the components of the e-commerce platform 306. The platform networks may comprise one or more public and/or private networks and include any number of hardware and/or software components capable of hosting and managing the networked communication among devices of the e-commerce platform 306.

As depicted in FIG. 3, the components of the e-commerce platform 306 may include the analytics server 318 and a platform database 308. However, the embodiments may include additional or alternative components capable of performing the operations described herein. In some implementations, certain components of the e-commerce platform 306 may be embodied in separate computing devices that are interconnected via one or more public and/or private internal networks (e.g., network 328). In some implementations, certain components of the e-commerce platform 306 may be integrated into a single device. For instance, the analytics server 318 may host the platform database 308.

Furthermore, the e-commerce platform 306 may include the analytics server 318 configured to serve various functions of the e-commerce platform 306. Non-limiting examples of such functions may include webservers hosting webpages (or at least a portion of a webpage, such as the checkout portion) on behalf of merchants (e.g., online stores), security servers executing various types of software for monitoring web traffic (e.g., determining that a customer has reached a checkout page using the electronic device), and database servers hosting various platform databases 308 of the e-commerce platform 306, among others.

The illustrative e-commerce platform 306 is shown and described as having only one analytics server 318 performing each of the various functions of the e-commerce service. For instance, the analytics server 318 is described as serving the functions of executing the allocation engine 322 and a webserver (hosting webpages for online stores and account administration. It is intended that FIG. 3 is merely illustrative and that embodiments are not limited to the description of workflow allocation system 300 or the particular configuration shown in FIG. 3. The software and hardware of the analytics server 318 may be integrated into a single distinct physical device (e.g., a single analytics server 318) or may be distributed across multiple devices (e.g., multiple analytics servers 318).

The platform database 308 may store and manage data records concerning various aspects of the e-commerce platform 306, including information about, for example, actors (e.g., merchants, consumers, or platform administrators), electronic devices, merchant offerings (e.g., products, inventory, or services), authentication protocols, authentication credentials (e.g., user's passwords or other data needed for authenticating the customers), various metrics and statistics, machine-learning models, merchant pages hosting merchant stores, and other types of information related to the e-commerce platform 306 (e.g., usage and/or services).

The platform database 308 may also include various libraries and lookup data tables including detailed data needed to perform the methods described herein, such as allocating workflow to different customers. For instance, the analytics server 318 may generate a data table associated with different merchants indicating how and when to present challenges and allocate workflows. The analytics server 318 may use this data table to identify the TPCS 342 and/or the challenge protocols executed and presented on the electronic device 302. The analytics server 318 may also use the data table to allocate workflows (e.g., how to manage the virtual queue of customers and their respective electronic sessions). As used herein, a virtual queue refers to an arrangement (e.g., ordering or ranking) of customers (and their corresponding sessions) requesting to conduct an action, such as accessing a checkout page. The virtual queue may be represented by a set of data records where each data record corresponds to a customer and/or a customer session. Accordingly, the virtual queue may correspond to how the data record indicates an order or a ranking of the customer/sessions. For instance, each data record may include a time attribute indicating the time each customer requested to perform an action. The virtual queue may then represent the customers ordered in accordance with their data record's time attribute.

The data table may include various rules (e.g., defined rules), regulations, and thresholds discussed herein may be set by the analytics server 318 or a system administrator of the e-commerce platform 306. Additionally or alternatively, the customer operating the electronic device 302 and/or the merchant server 340 may input or modify the defined rules. For instance, a customer operating the electronic device 304 may add or remove different devices from a trusted list of devices. In another example, the customer may revise the list stored within the database and add a preferred TPCS and/or challenge.

The platform database 308 may be hosted on any number of computing devices having a processor (sometimes referred to as a database (DB) processor 320) and non-transitory machine-readable memory configured to operate as a DB memory 310 and capable of performing the various processes and tasks described herein. For example, one or more analytics servers 318 may host some or all aspects of the platform database 308.

A computing device hosting the platform database 308 may include and execute database management system (DBMS) 314 software, though a DBMS 314 is not required in every potential embodiment. The platform database 308 can be a single integrated database structure or may be distributed into any number of database structures that are configured for some particular types of data needed by the e-commerce platform 306. For example, a first database could store user credentials and be accessed for authentication purposes, and a second database could store raw or compiled machine-readable software code (e.g., HTML, JavaScript) for webpages such that the DB memory 310 is configured to store information for hosting webpages.

The computing device hosting the platform database 308 may further include a DB network interface 324 for communicating via platform networks of the e-commerce platform 306. The structure of the DB network interface 316 will depend on how the hardware of the platform database 308 interfaces with other components of the e-commerce platform 306. For example, the platform database 308 may be connected to the platform network with a network cable, and the DB network interface 324 may include, for example, a NIC, a computer port, and/or a network socket. The processor 320 directly performs or instructs all of the operations performed by the platform database 308.

Non-limiting examples of such operations may include processing queries or updates received from the analytics server 318, electronic device 302, and/or merchant server 340; preparing information for transmission via the platform network and/or the external networks 328, and processing data received via the platform network and/or the external networks 328. The processor 320 may be implemented by one or more processors that execute instructions stored in the DB memory 310 or other non-transitory storage medium. Alternatively, some or all of the DB processor 312 may be implemented using dedicated circuitry such as an ASIC, a GPU, or a programmed FPGA.

The DB memory 310 of the platform database 308 may contain data records related to, for example, customer activity, and various information and metrics derived from web traffic involving customer accounts. The data may be accessible to the analytics server 318. The analytics server 318 may issue queries to the platform database 308 and update data based upon, for example, successful or unsuccessful authentication sessions.

The analytics server 318 may be any computing device that comprises a processor 320 and non-transitory machine-readable storage media (e.g., server memory 326) and that is capable of executing the software for one or more functions such as allocation engine 322. In some cases, the server memory 326 may store or otherwise contain the computer-executable software instructions, such as instructions needed to execute the allocation engine 322. The software and hardware components of the analytics server 318 enable the analytics server 318 to perform various operations that serve particular functions of the e-commerce platform 306.

For example, the analytics server 318 that serves as a webserver may execute various types of webserver software (e.g., NGINX, Apache® or Microsoft IIS®). As another example, the analytics server 318 that serves as a security server may execute software for evaluating a customer using the TPCS 342 when the request is received from the electronic device 302. It is intended that these are merely examples and not intended to be limiting as to the potential arrangements or functions of the analytics server 318. Non-limiting examples of the analytics server 318 may include desktop computers, laptop computers, and tablet devices, among others.

The analytics server 318 may execute the allocation engine 322 that identifies suitable TPCSs associated with the merchant server 340 and instructs the TPCS 342 to execute the challenge protocol. The allocation engine 322 may also release different electronic sessions in accordance with various queue management methodologies. Even though the TPCS is described as being controlled or hosted by a third-party, in some implementations a first-party challenge service may, additionally or alternatively, be employed such as, for example, as an alternative to the third party challenge service. The location of the allocation engine 322 is merely an example. The allocation engine 322 may be executed by the analytics server 318 and/or by the electronic device 302 under the direction of the analytics server 318. Therefore, the allocation engine 322 can be performed by at least one of a customer's device or some other components of the e-commerce platform 306.

Additionally or alternatively, the allocation engine 322 could be provided by the e-commerce platform 306 as a separate web-based or cloud-based service. In some implementations, the allocation engine 322 is implemented at least in part by a user device such as the electronic device 302. Other implementations of the allocation engine 322 are also contemplated, such as a stand-alone service to evaluate users of any website and allocate a workflow offered by the website. While the allocation engine 322 is shown as a single component of the e-commerce platform 306, the allocation engine 322 could be provided by multiple different components that are in networked communication with the analytics server 318 executing the allocation engine 322.

The merchant server 340 may be any server associated with a merchant hosting an online store. The merchant server 340 may be any computing device hosting a website (or any other electronic platform) accessible to customers (e.g., via the electronic device 302) via the network 328. The merchant server 340 may include a processing unit and non-transitory machine-readable storage capable of executing various tasks described herein. The processing unit may include a processor with a computer-readable medium, such as a random access memory coupled to the processor. Non-limiting examples of the processor may include a microprocessor, an application-specific integrated circuit, and a field programmable object array, among others. Non-limiting examples of the merchant server 340 may include workstation computers, laptop computers, server computers, laptop computers, and the like. While the workflow allocation system 300 includes a single merchant server 340, in some embodiments the merchant server 340 may include a number of computing devices operating in a distributed computing environment.

The merchant server 340 may be configured to interact with one or more software modules of the same or different types depicted within the workflow allocation system 300. For instance, the merchant server 340 may execute software applications configured to host an electronic platform that may generate and serve various webpages to the electronic device 302. The electronic platform may also embed various graphical user interfaces generated by the analytics server 204. The online store hosted by the merchant server 340 may be configured to require user authentication based upon a set of user authorization credentials (e.g., username, password, biometrics, cryptographic certificate, and the like).

The TPCS 342 may be any server (e.g., a third-party server or a server that is associated with the merchant server 340) that can execute one or more challenge protocols and provide one or more response elements presented on the electronic device 302. TPCS 342 may be any computing device hosting one or input elements configured to evaluate a customer operating the electronic device 302 via the network 328. The TPCS 342 may include a processing unit and non-transitory machine-readable storage capable of executing various tasks described herein. The processing unit may include a processor with a computer-readable medium, such as a random access memory coupled to the processor. Non-limiting examples of the processor may include a microprocessor, an application-specific integrated circuit, and a field programmable object array, among others.

In a non-limiting example, the analytics server 318 may instruct the TPCS 342 to execute a challenge protocol and present one or more response elements on the electronic device 302 to evaluate a customer. The challenge protocol itself and/or the TPCS 342 may be customized in accordance with rules received from the merchant (e.g., via the merchant server 340). For instance, the analytics server 318 may receive a message from the merchant server 340 that a user having a user identifier (UID) has requested to access a checkout page on a website hosted or otherwise associated with the merchant server 340. The analytics server 318 may then receive data associated with how the customer performed during the challenge. As a result, the analytics server 318 may regulate how and when the customer can access the checkout page.

In another non-limiting example, the e-commerce platform 306 serves a page on the electronic device 302. The page, executing on the electronic device 302, may instruct the electronic platform 306 that is the customer has requested to checkout. The e-commerce platform 306 may then redirect the electronic device 302 to the TPCS 342 where the customer is presented a challenge. The e-commerce platform 306 then regulates the customer's access to the checkout page.

III. Example Methods of Allocating Workflows to Different Electronic Sessions

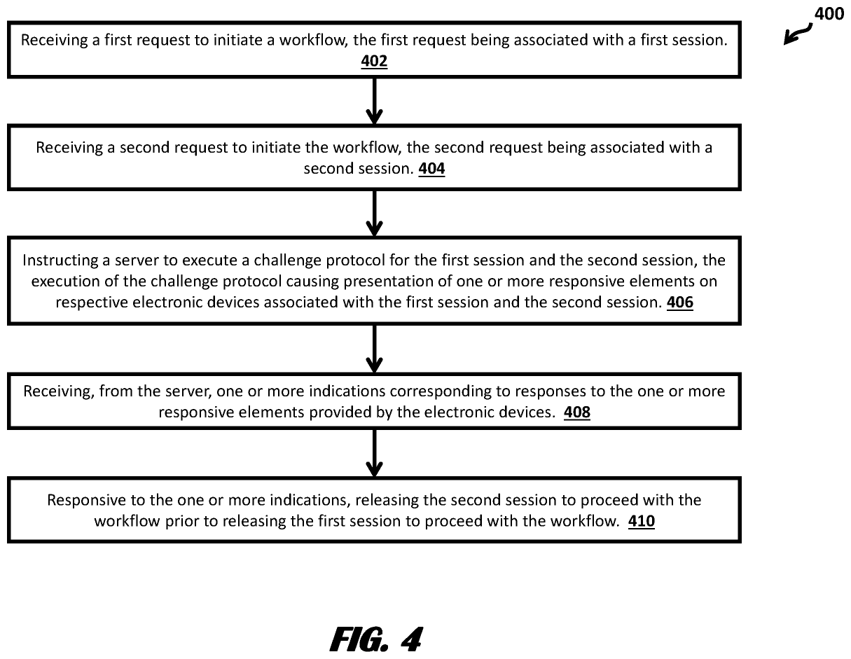

FIG. 4 illustrates a flowchart depicting operational steps for a workflow allocation system, in accordance with an embodiment. The method 400 describes how a server, such as the analytics server described in FIG. 3, may use a third-party challenge server (TPCS) to request customers to perform a challenge and allocate one or more workflows among different customers. For instance, the analytics server may use the method 400 to instruct a TPCS to present challenges to customers who have requested a checkout process to be executed. Using data associated with how the customers performed during the challenge, the analytics server may then generate a virtual queue and release each customer's request (for initiation of the workflow) in accordance with that customer's performance.

Even though the method 400 is described in the context of the analytics server using the TPCS, the challenge may be presented to the customers via other parties as well. For instance, the analytics server (or other server) may present the challenge to the customer instead of the TPCS. In another example, the merchant (or another server acting under instructions received from the merchant) may present the challenge. Even though the method 400 is described as being executed by the analytics server, the method 400 can be executed by any server and/or locally within a customer's trusted device (e.g., the electronic device 302 discussed in FIG. 3).

Additionally or alternatively, a server may execute the method 400 in other computer environments (other than the environments depicted in FIGS. 1-3). For instance, the method 400 may be executed by a server providing SaaS in a non-commerce infrastructure for any electronic platform regardless of whether the platform is related to e-commerce.

Additionally or alternatively, the method 400 may be executed by a webserver acting as both a webserver and an analytics server by hosting an online store and executing various methods described herein. For instance, the same server may host a website for a merchant configured to offer products for sale, generate and present the challenge, and allocate workflow to different electronic sessions. Furthermore, other configurations of the method 400 may comprise additional or alternative steps or may omit one or more steps altogether.

Before utilizing the analytics server to provide a dynamic presentation of a challenge protocol and/or allocating workflow requested by one or more customers in one or more electronic sessions, a merchant may define various rules in order to allow the analytics server to identify when and how to present a challenge, what challenge to present, and how to allocate workflow to different electronic sessions. This process may be referred to herein as the configuration of the workflow allocation system. After configuring the workflow allocation system, the analytics server may utilize the method 400 to communicate with a TPCS and/or analyze one or more electronic sessions to present a challenge via instructing the TPCS and to allocate workflow or computing resources to different customers (via their corresponding electronic sessions) accordingly.

During configuration, the analytics server may receive/retrieve challenge data from a merchant (e.g., operatively controlling the merchant's online store). The merchant may use the e-commerce platform (described in FIGS. 1-3) to provide various parameters of the challenge, such as triggering conditions for the challenge protocol (e.g., when the challenge may be presented during the customer journey). For instance, the merchant may indicate that a responsive element of a challenge protocol may be presented to the customer when the customer requests accessing a checkout page or otherwise initiates a checkout process. In some embodiments, a rule inputted by the merchant may indicate that challenges may be presented when a threshold number of customers have requested to checkout (or requested any other workflow to be initiated). For instance, the merchant may instruct the analytics server to present challenges and allocate workflow initiation among different customers (via their corresponding electronic sessions) when the number of customers who have requested to checkout is more than 25.

In some embodiments, the merchant may indicate data associated with particular products that would trigger execution of a challenge protocol and/or allocation of workflow initiation. For instance, the merchant may indicate that a responsive element of a challenge protocol may be presented to the customer when a customer has requested to initiate a checkout process for a particular product that is limited in inventory. For instance, the merchant may instruct the analytics server to allocate workflow initiations when the merchant's inventory for a particular product is fewer than a threshold amount (e.g., when the merchant has fewer than 50 widgets to sell, the analytics server may execute the method 400 to allocate workflow initiations and regulate corresponding electronic sessions, such as customers who are buying the widgets). In another example, the merchant may provide an attribute of a product that would trigger the allocation of workflows. For instance, the merchant may indicate a desire for the analytics server to allocate workflow initiation for customers who are purchasing limited edition basketball sneakers.

In a non-limiting example, the allocation of the sessions may correspond to the number of items within the inventory. For instance, if the analytics server determines that there are only 5 shoes left for a merchant, the analytics server may use the methods and systems discussed herein to rank the sessions (e.g., sessions that correspond to customers requesting to checkout) and only release the top five sessions.

In another example, the merchant may indicate which customers would receive a challenge. For instance, the merchant may indicate which customers may be presented with a responsive element of a challenge protocol (e.g., not all customers need to receive a challenge). In an embodiment, customers with existing user profiles (e.g., customers who are known to the merchant and/or have been previously verified by the merchant) may not need to be challenged or may be presented a particular challenge (e.g., a particular type of challenge or a challenge from a particular TPCS). In some embodiments, the merchant may provide customer attributes that would trigger a particular challenge. For instance, customers in Europe may receive different challenges than Canadian customers.

The merchant may also indicate attributes of the challenge protocol and/or a TPCS to present the challenge. The merchant may indicate what challenge may be executed and what type of responsive element may be presented to the customer in accordance with their attributes (e.g., customer attributes, product attributes, and/or commerce events). The merchant may indicate a list of approved TPCSs and a workflow and/or product attribute for which each TPCS may be instructed to execute a challenge protocol. For instance, the merchant may indicate the identification of a challenge protocol and/or a TPCS for Canadian customers who have initiated a checkout process to purchase limited-edition action figures.

The merchant can also identify the type of challenges to be executed (e.g., quizzes, visual challenges, ranking challenges, multiplayer gaming challenges, auditory challenges for visually impaired customers).

Additionally or alternatively, the merchant can identify attributes to be verified by the analytics server and/or the TPCS. For instance, the merchant may indicate that a certain customer can be prioritized when the customer owns a Non-Fungible Token (NFT) that satisfies certain criteria. The NFT may be associated with a product, brand, artist, merchant, or other entity or design. For instance, certain products may be associated with a list of NFTs (e.g., limited edition and/or collectible sneakers that are released in collaboration with a particular artist). The merchant may indicate that customers who own a particular NFT (that is associated with the artist) may be prioritized when the workflow is allocated among customers and their electronic sessions.

In another example, the merchant may indicate that if a customer (who has passed the challenge) owns an NFT that satisfies a criterion (e.g., is associated with the artist or is associated with the sneaker design), then the customer may be presented a particular challenge or may be prioritized when allocating the workflow. For instance, if two customers request to checkout and purchase a limited edition action figure, the customer who owns an NFT associated with the artist or the public figure associated with the action figure might be able to checkout (e.g., at least access a checkout page) before the second customer. In some embodiments, the criterion may be defined as owning a certain NFT. For instance, the analytics server may determine whether the merchant/customer owns a particular NFT. The NFT may be a particular/certain NFT or one of a set of NFTs.

In those embodiments, the analytics server may query an electronic wallet associated with the customer and determine whether the customer owns an NFT that satisfies merchant-defined or other criteria. In another example, the TPCS may execute various protocols (e.g., query one or more electronic wallets, ask questions, and the like) to determine whether the customer owns the NFT.

The merchant may also allow customers to select their own challenges by providing a list of different challenges and TPCSs to customers, which allows customers to leverage their existing relationships or previously saved data with different TPCSs. For instance, when generating a user profile, the customer may indicate a preference for a particular TPCS. The merchant may transmit an identifier of the customer's preferred TPCS to the analytics server at configuration time (or at any other time before the challenge is presented to the customer). As a result, the analytics server may instruct the identified TPCS when challenging the customer. For instance, the analytics server may identify an application associated with the preferred TPCS and invoke the identified application instructing it to present a challenge.

The merchant may configure the workflow allocation system by selecting and installing one or more applications associated with different TPCSs within the e-commerce platform (FIGS. 1-3). The merchant may also grant cart access to the system and allow the system to analyze the electronic shopping cart (e.g., to identify whether an electronic session associated with a customer includes purchasing a particular item that would trigger a challenge). Additionally or alternatively, the merchant may grant access to the TPCS to analyze the electronic shopping cart.

The merchant may also input a method of allocation for workflow initiation requests. For instance, the merchant may indicate that customers may be allowed to initiate the workflow process in accordance with how they performed during the challenge or in accordance with a time that each customer requested initiation of the workflow. In another example, the merchant may request that the analytics server assigns different electronic sessions (e.g., customers who have requested initiation of a workflow) to different clusters (e.g., virtual buckets) and uses the clusters to release electronic sessions to access the workflow. In another example, the merchant may indicate that certain customers may be prioritized over other customers, such as disabled customers may be prioritized over other customers. In another example, priority may be given to customers having particular attributes/statuses. In another example, the merchant may indicate that workflow may be allocated in a first-in-first-out manner.

The analytics server may store the data received from the merchant in a data table (e.g., lookup table). This data table may include data that is needed to determine when, how, and for whom to present a challenge and how to allocate workflow initiations. In addition to the merchant-inputted data, the analytics server may use defined or default data to present the challenge and/or allocate workflow initiations.

The analytics server may monitor different electronic sessions associated with an online store and determine that at least two customers (having corresponding electronic sessions) have requested initiation of a workflow place. At step 402, the analytics server may receive the first request to initiate a workflow, the first request being associated with a first session. At step 404, the analytics server may receive a second request to initiate the workflow, the second request being associated with a second session.

At step 406, the analytics server may instruct a server to execute a challenge protocol for the first session and the second session, the execution of the challenge protocol causing the presentation of one or more responsive elements on respective electronic devices associated with the first session and the second session. When the customer requests initiation of a workflow (e.g., clicks on a checkout button or requests a product to be added to their electronic shopping cart) or reaches a particular commerce intersection that corresponds to a workflow (e.g., a commerce event defined by the merchant at configuration time), and/or when a product's data matches attribute(s) defined by the merchant, the analytics server may identify an appropriate TPCS. As discussed herein, the analytics server may monitor the customer's activities throughout their session. After each workflow request by the customer, the analytics server may determine whether the requested workflow triggers a challenge (e.g., based on the merchant's preferences or default settings).

Additionally or alternatively, the analytics server may also monitor data, including within the customer's electronic shopping cart. For instance, when the customer adds a product to their electronic shopping cart, the analytics server may analyze data associated with the added product (e.g., metadata associated with the product) and determine whether the product should trigger a challenge.

The analytics server may communicate with the merchant server and/or a webserver hosting the merchant's online store to monitor the customer's electronic session. For instance, the analytics server may receive an indication that the user has initiated a transaction using an electronic device. In another example, the analytics server may receive, via an electronic message originating from the merchant's server, an indication that a user has added multiple products to their electronic shopping cart and has now requested access to a checkout page of the merchant's online store to complete the transaction. The indication may also include a user identifier (UID), a cart identifier, and/or data associated with the products added to the electronic shopping cart by the customer. The analytics server may use this information to identify the user, the user's trusted devices, authorized communication channels, preferred challenges and/or TPCSs, and any other information needed to provide the customer with an appropriate challenge and/or allocate workflow to the customer (e.g., allow the customer to access the checkout page). In some embodiments, the analytics server may need no identifying information and rely on TPCS to authenticate or evaluate the customer.

In addition to the indication that the customer has requested initiation of a workflow (e.g., the customer has requested a checkout page), the analytics server may also receive a UID. The UID may be a unique identifier associated with the customer, which may be received from the merchant server, webserver, and/or the customer device. In a non-limiting example, the user may have provided login credentials (e.g., name, login ID, email address, phone number, mailing address, or other personally-identifiable information) when logging in to the online store. In some configurations, when the indication that a customer is attempting to checkout is received from the merchant server, the UID may be received from the merchant's server and may include any data that identifies the customer (e.g., a unique identifier associated with the customer or the customer's account, such as a cart identifier). In another example, the merchant server may transmit a unique cart ID to the analytics server that can be used to identify the customer, the electronic shopping cart, and/or the products added to the electronic shopping cart. Using the unique cart ID, the analytics server may retrieve data (e.g., metadata) associated with products within the electronic shopping cart.

Additionally or alternatively, the analytics server may use a unique identifier of the customer's device, such as an IP address, MAC address, or any other identifier associated with the customer's device to identify the customer. The analytics server may parse the electronic message to determine a unique identification of the customer's device. The analytics server may then query a list of known unique identifiers (or unique identifiers that are associated with a customer) to identify the customer based on the unique identifier. For instance, the analytics server may match the IP address of the customer device (received via the message transmitted by the merchant server) with an IP address associated with the customer (e.g., an IP address that is predominantly used by the customer to login and access services provided by the analytics server). Using the UID, the analytics server may then query a database to identify an account of the user, which may include data needed to provide a suitable challenge for the customer and/or allocate the workflow.

Using the lookup data table, the analytics server may identify a TPCS or a challenge to present to the customers for their respective electronic sessions. The analytics server may analyze the data associated with the one or more products included within the customers' electronic shopping cart, data associated with each customer, and the workflow initiation request to identify which TPCS to contact and/or which challenge to instruct the identified TPCS to present. If the workflow initiation is identified as triggering a challenge or allocation of the workflow among different customers, the analytics server may determine (e.g., using the lookup data table) whether a particular TPCS has been identified that would correspond to the workflow, product attribute, and/or customer attribute. If no TPCS is identified, the analytics server may use a default TPCS.

The TPCS may be selected based on an attribute of the product. For instance, if the product added to the electronic shopping cart is a clothing item, the analytics server may select a different TPCS than if the product is a prescription drug. Additionally or alternatively, the TPCS may be selected based on data associated with a customer and/or their device. For instance, certain customers may have preferences regarding which TPCS is presented. In some other embodiments, the customer's geographic location or electronic device may dictate the TPCS.

After identifying the appropriate TPCS, the analytics server may use the lookup data table (and/or other data available, such as regulatory rules or default rules) to determine one or more attributes of the challenge protocol. For instance, the analytics server may determine the type of challenge to be presented to the customer. The lookup data table may include data associated with the challenge protocol (a type of the challenge, such as visual, questionnaire, and the like) or a duration of the challenge (timed vs. untimed) to be presented to the customer.

The analytics server may then instruct the TPCS to present the challenge by displaying one or more responsive elements on the customer's device (e.g., direct the customer device to the challenge). The instructions may indicate what type of challenge is to be presented to the customer and may include customer data. For instance, the instructions may indicate preliminary data associated with the customer (e.g., customer's location or age), such that the TPCS can identify a suitable challenge accordingly. For instance, the instruction may allow the challenge to display in the customer's language.

The instruction may also include validation thresholds. The threshold may correspond to a degree of verification for a challenge. That is, the threshold may indicate how accurate the customer may be to pass the challenge. The threshold may depend on customer data and/or data associated with the product(s) included within the electronic shopping cart. For instance, the customer may have a higher threshold when purchasing prescription drugs than when purchasing a product that is readily available without a prescription (e.g., vitamins), which indicates that the customer may answer more questions correctly in the former scenario.

In some embodiments, the challenge (e.g., one or more responsive elements) may be based on (e.g., configured by the analytics server for) an attribute of the product added to the electronic shopping cart. For instance, if the product is a pair of collectible sneakers, the challenge protocol may include responsive elements that quiz the customer's knowledge regarding the collectible sneakers. Alternatively, the challenge protocol may be executed by the analytics server itself. For instance, the analytics server may display the one or more responsive elements configured to challenge the customer.

The analytics server may repeat the method 400 (and particularly step 406) for each customer who has requested initiation of the workflow. For instance, when three customers (having three separate sessions) request a checkout page to complete a transaction, the analytics server may repeat the step 406 (and other steps of the method 400 in some embodiments) for each electronic session associated with each customer within a group of customers. As a result, the analytics server may select either different or the same challenges to be presented to different customers and their respective electronic sessions. For instance, because the first session (associated with a first customer) is identified to be associated with a Canadian IP address, the analytics server may select a challenge that is specific to Canadian customers. The second session (associated with the second customer) may be identified as associated with a European IP address and may receive a default challenge. Moreover, the third session (associated with the third customer) may receive a different challenge than the first two customers because a UID associated with the third session may indicate that the third customer is younger than 18 years old.

At step 408, the analytics server may receive one or more indications corresponding to responses to the one or more responsive elements provided by the electronic devices. Upon the TPCS presenting the challenge, the TPCS may monitor the customer's performance. The TPCS may then transmit the monitored data to the analytics server and/or the merchant server. For instance, after the execution of the challenge, the analytics server may receive metadata associated with the customer's performance. The data received from the TPCS is also referred to herein as the customer performance data. The customer performance data may include the time of completion of a challenge or the percentage of the right answers provided by the customer. Additionally or alternatively, the customer performance data may include any other metric administered by the TPCS. In some embodiments, the customer performance data may be in the form of one or more scores that are based on the customer's performance. The indication may also include a binary flag indicating whether the customer has completed the challenge successfully.

At step 408, the analytics server may, responsive to the one or more indications, release the second session to proceed with the workflow before releasing the first session to proceed with the workflow. The analytics server may release the second session before the first session if the TPCS indicates that the second user's (associated with the second session) performance during the challenge satisfies a defined criterion.

As used herein, releasing an electronic session may refer to the analytics server allowing the electronic session to initiate the workflow. For instance, if the workflow requested is a checkout process, the analytics server may release an electronic session by allowing the electronic session to access a checkout page or directing the electronic session to a checkout page.

Upon receiving each user's performance data associated with the challenge, the analytics server may form a virtual queue and may prioritize different electronic sessions in accordance with their respective performance data received from the TPCS.

Additionally or alternatively, the analytics server may assign different sessions to different virtual buckets in accordance with their respective performance data associated with their respective electronic sessions. For instance, the analytics server may assign each electronic session to a virtual bucket or cluster of electronic sessions in accordance with their respective performance data. For instance, the analytics server may form three virtual buckets where each virtual bucket is associated with a performance range (e.g., time of completion or percentage of accurate responses). Then, the analytics server may assign each electronic session to one virtual bucket in accordance with how they performed during the challenge.

In a non-limiting example, the analytics server may form three virtual buckets, each bucket representing a set of customers. The first virtual bucket may be designated for electronic sessions associated with customers who finished the challenge in less than a minute. The second virtual bucket may be designated for electronic sessions associated with customers who finished the challenge in between one and two minutes. The third virtual bucket may be designated for electronic sessions that are associated with customers who finished the challenge in more than two minutes. As different customers request initiation of a workflow (e.g., request to checkout), the analytics server may assign each electronic session for the respective customer to their respective virtual bucket.

In some configurations, virtual buckets may be formed based on more than one attribute and/or may be formed based on attributes that are not performance-based. For instance, a virtual bucket may correspond to disabled Canadian customers who passed a challenge. In another example, a virtual bucket may correspond to preferred customers (e.g., customers with a preferred status) who completed the challenge regardless of how they performed during the challenge.

After generating the virtual buckets and assigning the electronic session to different virtual buckets, the analytics server may release the electronic session according to their respective virtual buckets. For instance, the analytics server may release all the electronic sessions within the first virtual bucket until there are no more electronic sessions associated with the first virtual bucket. Then, the analytics server may release all the electronic sessions assigned to the second virtual bucket before releasing all electronic sessions within the third virtual bucket.

Additionally or alternatively, the analytics server may release various electronic sessions within different buckets in parallel, such that a slow customer does not create a bottleneck and create inefficiencies for other electronic sessions assigned to subsequent virtual buckets. For instance, the analytics server may (in parallel) release one electronic session from each of the three virtual buckets.

In some embodiments, the analytics server may prioritize different electronic sessions that are assigned to the same virtual bucket. For instance, electronic sessions assigned to the first virtual bucket may be released using a first-in-first-out protocol where a timestamp of each electronic session requesting initiation of the workflow (or a timestamp of each electronic session being assigned to the virtual bucket) determines how different electronic sessions are going to be released. In another embodiment, certain electronic sessions (within the same virtual bucket) may be prioritized based on an attribute of the customer associated with the electronic session. For instance, a customer who is disabled (determined based on their user profile or UID) may be prioritized over another customer (in the same bucket) even if the second customer requests initiation of the workflow before the disabled customer.

In some embodiments, releasing the electronic session (queue management) may depend on the resources and efficiencies of a downstream application. For instance, if the workflow is being executed by a third party application/vendor and/or if the workflow initiation requires another application to perform an action (whether the application is internal or third-party), the analytics server may manage the virtual queue and release the electronic sessions in accordance with the downstream application. For instance, if the downstream application indicates that it can only initiate workflow for 30 electronic sessions per minute, the analytics server may only release 30 electronic sessions per minute where the releasing is performed based on each electronic session's performance during the challenge.

The analytics server may use a variety of queue management methods to release different electronic sessions. Therefore, the analytics server may not only use the bucking method.

In a non-limiting example, using the method 400, the analytics server may manage a virtual queue associated with a group of customers who are attempting to purchase a particular product. In that example, a merchant or a system administrator may define a trigger for a queue management process for a checkout. For example, the merchant may configure the analytics server to implement queue management based on the product being purchased by customers (e.g., a product having metadata indicating it is a limited edition, such as new leather sneakers), a number of customers who have requested a workflow, such as a checkout process (e.g., if the number is higher than a threshold, then the queue management automatically starts), remaining inventory associated with a particular product (e.g., analytics server may dynamically identify that the merchant only has 50 sneakers left and then start queue management for customers who are attempting to purchase the product), receipt of a merchant request (e.g., utilize a queue to give the appearance of demand), or resource availability of a downstream software application (e.g., existing capacity for more checkouts but the shipping software or vendor has limited resources so regulate how/when customers check out).

After the customer requests a checkout page, the analytics server may act as a gate before the customer is allowed to access (view) the checkout page. For instance, depending on the customer's position within the virtual queue (e.g., when the customer requested to access the checkout page in relation to other customers who have requested to access checkout pages to purchase the same product), the queue management may delay the customer's access to the checkout page that allows the customer to complete the purchase. While waiting, the customer may see a predefined image (e.g., spinner indicating a loading page), a banner asking the customer to wait, a targeted advertisement, or a page displaying the customer's current position in the queue and/or estimated time until access will be granted.

The analytics server may create a virtual queue that includes a number of virtual buckets where each virtual bucket indicates a priority of accessing the checkout page. The analytics server may assign the customers to different virtual buckets and provide access for each customer based on their respective assigned virtual buckets.

The analytics server may assign each customer to a virtual bucket based on a score that depends on how the customer performed in a challenge. When a customer requests to checkout, the analytics server may instruct a TPCS to present a challenge on the customer's device. The merchant may configure various parameters of the challenge, such as the type of challenges to be presented (e.g., quizzes, visual challenges, games, multiplayer games, Battle Royale games) or the type of the customer who receives the challenge (e.g., visually impaired customers receive customized challenges).

After execution of the challenge, the analytics server may receive metadata associated with the customer's performance (e.g., time of completion or percentage of the right answers). Based on the performance, the analytics server may assign the customer to different virtual buckets. For instance, the analytics server may prioritize a customer because their performance indicates a likelihood of the customer being human (and not an automated bot) or a super fan (and not a casual buyer). The analytics server may also consider customer attributes to augment the allocation of workflow and/or assignment of the customer to a virtual bucket. For instance, visually impaired customers may be assigned to the most prioritized bucket, or users with gold status (or customers who have purchased more than a predetermined amount from the merchant) may be prioritized even though their performance was not satisfactory. Alternatively, the analytics server may obtain metadata passively from other data sources, such as an indication of music played on a playlist to determine whether the customer is truly a fan.

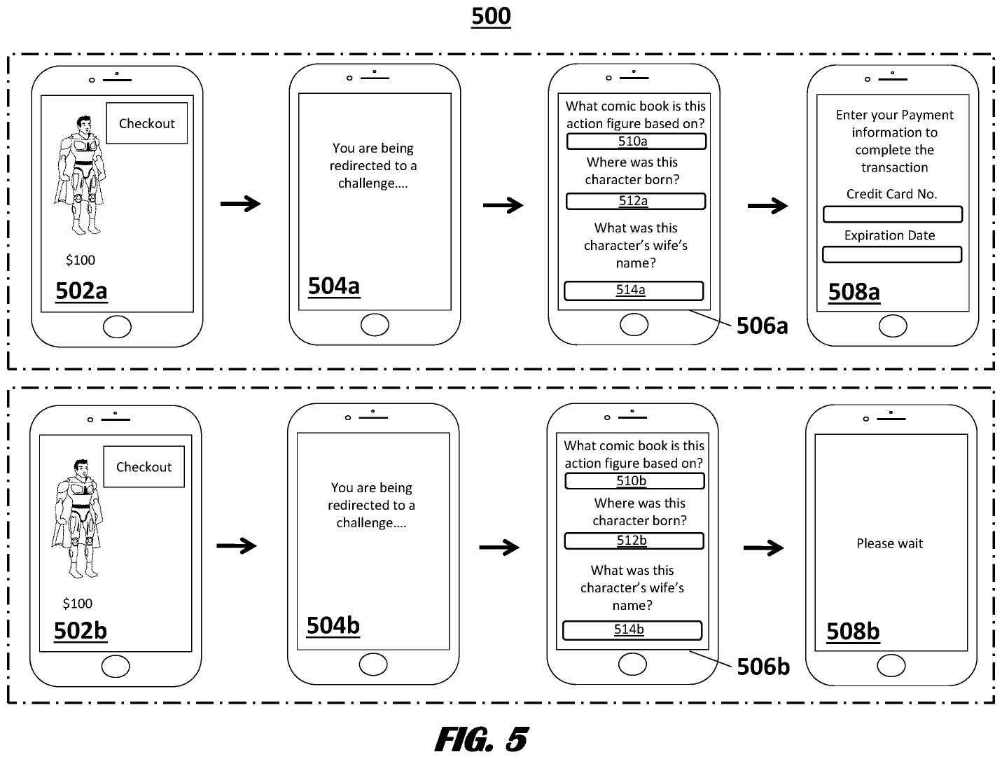

Referring now to FIG. 5, a non-limiting example of providing a challenge to a customer and regulating their access to a checkout page is illustrated. The example 500 illustrates how two customers purchasing collectible action figures can request a checkout page at the same time (or substantially the same time) but access the checkout page at different times. Accordingly, the example 500 illustrates how the analytics server can manage/regulate a virtual queue for the initiation of a workflow (in this case a checkout process) between an electronic session associated with customer A and an electronic second session associated with customer B. In the depicted embodiment, customer A views the graphical user interfaces (GUIs) 502a-508a, and customer B views the GUIs 502b-508b.

In the depicted embodiment, both customers attempt to purchase an action figure at the same time (or substantially the same time). However, one customer is able to reach a checkout page before the second customer. As depicted on GUIs 502a-b, the analytics server determines that customers A and B have accessed an online store and have added an action figure to their respective electronic shopping carts. The analytics server may query a lookup data table associated with the online store and determines that the action figure is included within a list of products that trigger a challenge protocol. The lookup data table may or may not include a preferred TPCS. However, the lookup data table may indicate that the merchant would like to ensure that customers who are bigger fans are prioritized over casual fans. As a result, the analytics server optionally displays the GUIs 504a-b indicating that the customers are being re-directed to a challenge. The analytics server then identifies a TPCS and instructs the TPCS to present the challenge displayed on the GUI 506a-b.

The challenge ensures that the action figure is prioritized to customers who answer at least two out of three questions to the depicted quiz correctly. The analytics server may include one or more attributes of the challenge protocol itself within the instructions, such that the TPCS presents suitable responsive elements. For instance, the challenge protocol may include presenting responsive elements depicted in the GUIs 506a-b.

The GUIs 506a-b depict an embodiment in which the TPCS presents a quiz to the user and provides input elements 510a-514a and 510b-514b allowing customers to input a response. After executing the challenge protocol depicted on the GUIs 506a-b, the TPCS may transmit each customer's performance data back to the analytics server. The customer performance data indicates that customer A responded correctly to all the responsive elements of the challenge. However, customer B responded to two questions correctly. The analytics server then releases the electronic session associated with customer A before releasing the electronic session associated with customer B. As a result, customer A is directed to the checkout page 508a where customer A can complete the transaction. In contrast, customer B is directed towards the GUI 508b where customer B is instructed to wait. Depending on other customers' performances, the analytics server may release the electronic session associated with customer B.

In an embodiment, a computer-implemented method comprises receiving, by a processor, a first request to initiate a workflow, the first request being associated with a first session; receiving, by the processor, a second request to initiate the workflow, the second request being associated with a second session; instructing, by the processor, a server to execute a challenge protocol for the first session and the second session, the execution of the challenge protocol causing presentation of one or more responsive elements on respective electronic devices associated with the first session and the second session; receiving, by the processor from the server, one or more indications corresponding to responses to the one or more responsive elements provided by the electronic devices; and responsive to the one or more indications, releasing, by the processor, the second session to proceed with the workflow before the first session to proceed with the workflow.

The workflow may be a checkout process.

The first request and the second request may be assigned to a cohort of requests received by the processor in accordance with at least one attribute of the first request or the second request.

The processor may release one or more sessions within the cohort of requests before releasing one or more sessions within the second cohort of requests.

The processor may release one or more sessions within the cohort of requests in parallel with releasing one or more session within a second cohort of requests.

The processor may instruct the server to execute the challenge protocol responsive to a number of requests received satisfying a threshold.

The processor may instruct the server to execute the challenge protocol responsive to the workflow being associated with a product having an attribute that satisfies a threshold.

The processor may instruct the server to execute the challenge protocol responsive to receiving a request from a merchant computing device associated with the workflow.

The processor may receive, from the TPCS, a ranked or ordered list of sessions including at least the first and second sessions and release the sessions in that order while product inventory is available.

A characteristic of the challenge protocol may be based on a location associated with the first session or the second session, an attribute of a product associated with the workflow, or a customer profile associated with the first session or the second session.

In another embodiment, a machine-readable storage medium comprises computer-executable instructions stored thereon that, when executed by one or more processors, cause the one or more processors to perform operations comprises receiving a first request to initiate a workflow, the first request being associated with a first session; receiving a second request to initiate the workflow, the second request being associated with a second session; instructing a server to execute a challenge protocol for the first session and the second session, the execution of the challenge protocol causing presentation of one or more responsive elements on respective electronic devices associated with the first session and the second session; receiving, from the server, one or more indications corresponding to responses to the one or more responsive elements provided by the electronic devices; and responsive to the one or more indications, releasing the second session to proceed with the workflow prior to releasing the first session to proceed with the workflow.

The workflow may be a checkout process.

The first request and the second request may be assigned to a cohort of requests received by the processor in accordance with at least one attribute of the first request or the second request.

The instruction may further cause the processor to release one or more sessions within the cohort of requests before releasing one or more sessions within a second cohort of requests.

The instruction may further cause the processor to release one or more sessions within the cohort of requests in parallel with releasing one or more session within a second cohort of requests.

The instruction may further cause the processor to instruct the server to execute the challenge protocol responsive to a number of requests received satisfying a threshold.

The instruction may further cause the processor to instruct the server to execute the challenge protocol responsive to the workflow being associated with a product having an attribute that satisfies a threshold.

The instruction may further cause the processor to instruct the server to execute the challenge protocol responsive to receiving a request from a merchant computing device associated with the workflow.

A characteristic of the challenge protocol may be based on a location associated with the first session or the second session, an attribute of a product associated with the workflow, or a customer profile associated with the first session or the second session.

In another embodiment, a computer system comprises a server having a processor, the server configured to be in communication with a customer device, the server configured to receive a first request to initiate a workflow, the first request being associated with a first session; receive a second request to initiate the workflow, the second request being associated with a second session; instruct a server to execute a challenge protocol for the first session and the second session, the execution of the challenge protocol causing presentation of one or more responsive elements on respective electronic devices associated with the first session and the second session; receiving from the server, one or more indications corresponding to responses to the one or more responsive elements provided by the electronic devices; and responsive to the one or more indications, release the second session to proceed with the workflow prior to releasing the first session to proceed with the workflow.

The workflow may be a checkout process.

The foregoing method descriptions and the process flow diagrams are provided merely as illustrative examples and are not intended to require or imply that the operations of the various embodiments must be performed in the order presented. The operations in the foregoing embodiments may be performed in any order. Words such as “then,” “next,” etc. are not intended to limit the order of the operations; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The operations of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
receiving, by a processor, a first request to initiate a workflow, the first request being associated with a first session;
receiving, by the processor, a second request to initiate the workflow, the second request being associated with a second session;
instructing, by the processor, a server to execute a challenge protocol for the first session and the second session, the execution of the challenge protocol causing presentation of one or more responsive elements on respective electronic devices associated with the first session and the second session;
receiving, by the processor from the server, one or more indications corresponding to responses to the one or more responsive elements provided by the electronic devices; and
responsive to the one or more indications, releasing, by the processor, the second session to proceed with the workflow prior to releasing the first session to proceed with the workflow.

2. The computer-implemented method of claim 1, wherein the workflow is a checkout process.

3. The computer-implemented method of claim 1, wherein the first request and the second request are assigned to a cohort of requests received by the processor in accordance with at least one attribute of the first request or the second request.

4. The computer-implemented method of claim 3, wherein the processor releases one or more sessions within the cohort of requests before releasing one or more sessions within a second cohort of requests.

5. The computer-implemented method of claim 3, wherein the processor releases one or more sessions within the cohort of requests in parallel with releasing one or more session within a second cohort of requests.

6. The computer-implemented method of claim 1, wherein the processor instructs the server to execute the challenge protocol responsive to a number of requests received satisfying a threshold.

7. The computer-implemented method of claim 1, wherein the processor instructs the server to execute the challenge protocol responsive to the workflow being associated with a product having an attribute that satisfies a threshold.

8. The computer-implemented method of claim 1, wherein the processor instructs the server to execute the challenge protocol responsive to receiving a request from a merchant computing device associated with the workflow.

9. The computer-implemented method of claim 1, wherein a characteristic of the challenge protocol is based on a location associated with the first session or the second session, an attribute of a product associated with the workflow, or a customer profile associated with the first session or the second session.

10. A machine-readable storage medium having computer-executable instructions stored thereon that, when executed by one or more processors, cause the one or more processors to perform operations comprising:
receiving a first request to initiate a workflow, the first request being associated with a first session;
receiving a second request to initiate the workflow, the second request being associated with a second session;
instructing a server to execute a challenge protocol for the first session and the second session, the execution of the challenge protocol causing presentation of one or more responsive elements on respective electronic devices associated with the first session and the second session;
receiving, from the server, one or more indications corresponding to responses to the one or more responsive elements provided by the electronic devices; and
responsive to the one or more indications, releasing the second session to proceed with the workflow prior to releasing the first session to proceed with the workflow.

11. The machine-readable storage medium of claim 11, wherein the workflow is a checkout process.

12. The machine-readable storage medium of claim 11, wherein the first request and the second request are assigned to a cohort of requests received by the processor in accordance with at least one attribute of the first request or the second request.

13. The machine-readable storage medium of claim 12, wherein the instructions cause the one or more processors to release one or more sessions within the cohort of requests before releasing one or more sessions within a second cohort of requests.

14. The machine-readable storage medium of claim 12, wherein the instructions cause the one or more processors to release one or more sessions within the cohort of requests in parallel with releasing one or more session within a second cohort of requests.

15. The machine-readable storage medium of claim 10, wherein the instructions cause the one or more processors to instruct the server to execute the challenge protocol responsive to a number of requests received satisfying a threshold.

16. The machine-readable storage medium of claim 10, wherein the instructions cause the one or more processors to instruct the server to execute the challenge protocol responsive to the workflow being associated with a product having an attribute that satisfies a threshold.

17. The machine-readable storage medium of claim 10, wherein the instructions cause the one or more processors to instruct the server to execute the challenge protocol responsive to receiving a request from a merchant computing device associated with the workflow.

18. The machine-readable storage medium of claim 10, wherein a characteristic of the challenge protocol is based on a location associated with the first session or the second session, an attribute of a product associated with the workflow, or a customer profile associated with the first session or the second session.

19. A computer system comprising:
a server having a processor, the server configured to be in communication with a customer device, the server having a processor configured to:
receive a first request to initiate a workflow, the first request being associated with a first session;
receive a second request to initiate the workflow, the second request being associated with a second session;
instruct a server to execute a challenge protocol for the first session and the second session, the execution of the challenge protocol causing presentation of one or more responsive elements on respective electronic devices associated with the first session and the second session;
receiving from the server, one or more indications corresponding to responses to the one or more responsive elements provided by the electronic devices; and
responsive to the one or more indications, release the second session to proceed with the workflow prior to releasing the first session to proceed with the workflow.

20. The computer system of claim 19, wherein the workflow is a checkout process.
